(19) United States
(12) Patent Application Publication
(10) Pub. No.: US 2021/0110326 A1
(43) Pub. Date: Apr. 15, 2021

(54) ROUTE-BASED DIGITAL SERVICE MANAGEMENT

(71) Applicants: Jaroslaw J. Sydir, San Jose, CA (US); Bin Li, Portland, OR (US); Thijs Metsch, Bruehl (DE)

(72) Inventors: Jaroslaw J. Sydir, San Jose, CA (US); Bin Li, Portland, OR (US); Thijs Metsch, Bruehl (DE)

(21) Appl. No.: 17/131,429

(22) Filed: Dec. 22, 2020

(51) Int. Cl. G06Q 10/06; G06Q 50/30; G06Q 30/00; G01C 21/34; G05D 1/02; G08G 1/00; H04L 29/08

(52) U.S. Cl. CPC G06Q 10/06315; G06Q 50/30; G06Q 30/016; G06Q 10/02; G05D 1/0297; G08G 1/22; H04L 67/322; G01C 21/3438

(57) ABSTRACT

Various systems and methods for route-based digital service management are described herein, comprising receiving a request for service, such as a user request for service from a MaaS or digital service provider, estimating digital service usage with respect to the request, determining a MaaS route using the request and the estimated digital service usage, selecting an orchestration strategy comprising a server type using the estimated digital service usage, and scheduling a MaaS vehicle for the determined MaaS route in response to the request using the selected orchestration strategy and the determined candidate MaaS route.

### TECHNICAL FIELD

Embodiments described herein generally relate to mobile digital services, and in particular, to route-based digital service management.

### BACKGROUND

Mobility-as-a-service (MaaS) providers, such as ride share services, etc., offer digital services to passengers where system resources allow to increase service experience. Such offerings are often random or intermittent, depending on network and service capacity. Increasing capacity often involves substantial overprovisioning.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an example route-based service orchestration system.

FIG. 2 illustrates an example method of a route and orchestration planning process.

FIG. 3 illustrates an example system to process data to provide improved interactions with the surrounding operating environment.

FIG. 4 illustrates an example machine in form of a computer system 400, within which a set or sequence of instructions may be executed to cause the machine to perform any one of the methodologies discussed herein.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Providing consistent quality-of-service (QoS) of digital services for mobile users or passengers of MaaS providers or digital service providers is difficult due to, among other things, differences in available digital resources and loading of wireless and computer digital resources along a traveled MaaS route. Orchestration of edge services can be difficult when user mobility patterns fluctuate or are unknown, just as QoS-based route planning can be difficult if the availability of end-to-end or edge resources are unknown.

QoS differences can differentiate MaaS and digital service providers. Guaranteed QoS can be a premium service. The consistency of QoS along the MaaS route will be affected by a combination of performance of the wireless access network, the core network, and the service implementation.

Service deployment models are evolving to include more distributed components, with latency-sensitive services (or parts of services/micro-services) at the edge, nearer to the end user than centralized, cloud-based implementation. Delivery of service to mobile users is challenging, as the closest edge server changes over time and connectivity, such as wireless access, may not be uniform along the MaaS route. To control QoS of digital services for mobile users (e.g., mobile users of a MaaS provider are passengers at least while in transit), MaaS or digital service providers may deploy mobile edge servers within the MaaS vehicle and fixed edge servers and wireless communication resources along specific MaaS routes, or may partner with digital service providers to receive prioritized connection to resources.

The present inventors have recognized, among other things, that infrastructure resources along a potential or determined MaaS route to be traveled by a mobile user and the orchestration of required or requested services on these resources can be reserved in advance (e.g., before traveling the route, or while traveling the route, but with respect to forward portions, etc.) to guarantee requested QoS over the MaaS route.

Infrastructure resources, as used herein, can include one or more processing or communication resources (e.g., processing power, capability, or access to specific applications or capabilities, use of specific hardware, communication bandwidth or latency, storage available at the edge of the network (and thus more quickly accessible than in the cloud), etc. In certain examples, one or more of the starting time or the MaaS route for the requested service can be adjusted to prioritize QoS of digital services over the shortest ride time or ride distance. In other examples, the order of candidate selections provided to the user can be determined using the QoS of digital services of the candidate selections.

Route planning and selection of the vehicle for a passenger of a MaaS provider can be organized to enable the successful reservation of infrastructure resources and service orchestration and to control the usage of infrastructure resources, such as digital resources, throughout the system. The systems and methods disclosed herein can maximize utilization and efficiency of system resources, while increasing the number of digital services that can be delivered with guaranteed QoS, without inefficient overprovisioning.

Route planning and infrastructure resource selection or reservation can be made to optimize system efficiency and provide QoS guaranteed digital services to passengers of a MaaS provider. The system can track resource requirements in space and in time along with an orchestration plan for each passenger based on the planned routes of all passengers and can make the required reservations and perform service orchestration “just in time” based on this plan. The system can monitor digital resource usage as well as the progress of vehicles along their routes and can adjust the resource reservations, orchestration plan, and route selection based on changes due to traffic and unforeseen usage of digital resources.

In an example, optimization can be an iterative sequential process where route selection and orchestration are performed sequentially for each new passenger. Individual decisions, such as the estimation of resource requirements or selection of optimal route or set of routes, can be performed using heuristic algorithms or machine learning models (e.g., A*, game theory, fuzzy logic, system auctioning, etc.).

As an alternative to the iterative procedure, the joint optimization can be formulated as a constrained optimization problem and optimization techniques or machine learning techniques, such as reinforcement learning (e.g., specific to a passenger, etc.) can be applied to solve the optimization. Example algorithms include, among others: backtracking , q-learning , or Monte-Carlo based approaches.

The route-based service orchestration systems and method disclosed herein enables fine grained resource reservation and service orchestration in a highly dynamic system with mobile users. Route selection, resource reservation, and service orchestration decisions can be separately or jointly optimized to enable capacity planning into the future for mobile users. The system allows the MaaS provider to provide proper route selection and guaranteed QoS service while improving or maximizing system utilization (and hence optimizing a total cost of ownership (TCO) or return on investment (ROI)).

The systems and methods disclosed herein enable fine grained resource reservation and service orchestration in a highly dynamic system with mobile users, taking advantage of the ability to jointly optimize route selection and resource reservation or service orchestration decisions within a system where both are under the control of a MaaS provider. Such systems and methods improve future capacity planning and use of modern service orchestration constructs, such as containers or micro-services for mobile users, and allow MaaS providers to trade off travel-based criteria, such as travel time, against digital service based criteria, such a QoS, to more efficiently utilize infrastructure resources.

Infrastructure, such as roadside infrastructure operated by a MaaS provider or one or more other stakeholders (e.g., cloud providers, network operators, mobile virtual network operators (MVNOs), etc.) can connect MaaS vehicles to a core network with backhauls to the internet. Infrastructure can be reserved or requested by a MaaS provider to support requested applications, such as multi-tenancy in form of virtualization (VMs) or other isolation mechanisms (e.g., containers, etc).

Subsets of the infrastructure or the virtualized components can form a set of dynamic clusters. The dynamic clusters can exist for specified or requested time-periods in different forms. Example structure can include edge-to-cloud, at the edge only, or some combination or subset thereof (e.g. just provide storage at the edge, etc.).

Services can be passenger-oriented or vehicle or fleet-oriented, such as fleet management applications. Services can be specific to a particular user (e.g., John's Outlook email) or to a group of users (e.g. geo-distributed route weather prediction specific to a location and time). In an example, the user can request specific services to be available to them at the edge, such as a virtualized version of their home computer, sensitive data, personal information, etc. The system can ensure that requested services are available to the user while the user travels from point-to-point. Services can include low-latency communication, such as for gaming or video conferencing, or audio or video streaming, data transfer, etc. In other examples, services can include computational power, such as for virtual or augmented reality applications, applications of filters of real-world content, backgrounds, etc. In an example, data can be geo-fenced about a user, available at the edge, but not at the cloud or core network. Storage of the data may follow the user, such as using location information of the user, with certain limits (e.g., do not leave the country, do not leave a specific campus or defined area, do not bring data into an area of a competitor, etc.). In other examples, services can include a vehicle control application for a platoon of vehicles.

Services can be characterized in various dimensions, such as: (1) resource requirements of the components (e.g., #of virtual CPU (vCPU), CPU cycles, GPUs, network bandwidth etc.); (2) data and storage requirements (e.g., in notion of throughput, #of DB stored, etc.); (3) latency requirements (e.g., P99 latency requirements to satisfy safety requirements); (4) security requirements (e.g., governance rules to protect data (keep ‘X’ replicas, delete after use, etc.), support data anonymization, key protection etc.; (5) reliability requirements (e.g., required uptime/availability); (6) critically of the workload (e.g., in form of “violation budgets”); or (7) priority of the workloads (e.g., high priority (such as vehicle control information, etc), medium priority, best effort, etc.).

Complex hardware and software services or resources can be automatically arranged, coordinated, and managed as different orchestrations, such as: (1) service orchestration (e.g., software and hardware services delivered across one or more deployment infrastructures); (2) resource orchestration (e.g., orchestration of deployment infrastructures, composed of compute, storage, network and software resources, on which one or more services can run, etc.); or (3) infrastructure orchestration (e.g., to configure, bootstrap, and maintain the infrastructure landscape in a desired state).

Various tasks can be carried out by various stakeholders. Although described herein with respect to service and resource orchestration related tasks, others are contemplated and included herein, including but not limited to: migrating data, state and/or workload instances belonging to the service; planning required capacity or virtualized/rented infrastructure in a dynamic fashion to setup dynamic clusters of resources; and monitoring the state of workloads components and managing dynamic load patterns.

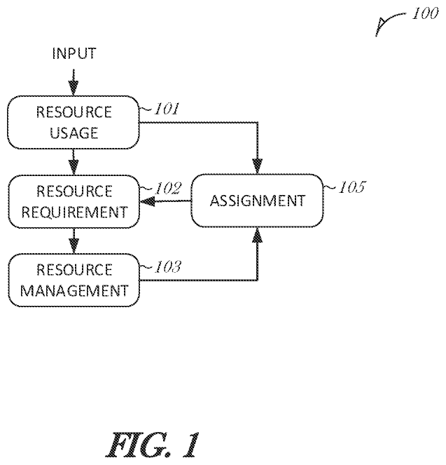

FIG. 1 illustrates an example route-based service orchestration system 100 comprising a resource usage circuit 101, a resource requirement circuit 102, a resource management circuit 103, a resource control circuit 104, and an assignment circuit 105.

The resource usage circuit 101 can receive information from or about a user or vehicle and estimate digital resource usage of passengers or vehicles using the received information. In certain examples, the estimation can be performed based on one or more of user input, such as received through a user interface (U/I) (e.g., a touchscreen input, etc.) or other user information, such as user location, profile, history, current usage, installed or frequently used applications, or security requirements.

The resource requirement circuit 102 can determine a candidate or planned MaaS route for the user, such as using the received information from or about the user, and aggregate resource usage of users in the system, such as along or with respect to the determined candidate or planned route separate from or in relation to a time of the determined candidate or planned route. In certain examples, the resource requirement circuit 102 can map resource usage in space and time based on planned routes for active users or vehicles. The resource requirement circuit 102 can track resource requirements or usage for individual servers or clusters deployed along the route or in vehicles. Estimates can be adjusted or updated as passengers and vehicles traverse their routes. The adjusted estimates can be aggregated.

The resource management circuit 103 can select a candidate orchestration strategy to manage and reserve infrastructure resources in specific core, fixed, or mobile edge servers. In certain examples, the resource management circuit 103 can reserve resources from a resource owner and form or manage clusters of mobile edge servers based on usage needs. The resource management circuit 103 can determine whether to serve an application at the edge or in the cloud, which resource to use for which application taking into account the expected timing of the usage, the priority of the application, and the application requirements along with availability of infrastructure resources. Where required, the resource management circuit 103 can implement end-to-end security (e.g., encryption, etc.). The resource management circuit 103 can manage infrastructure resources, orchestrate a resource management plan, monitor resource usage, and provide feedback to adjust for errors and dynamic changes to usage requirements.

The assignment circuit 104 can assign or schedule vehicles to routes and passengers to vehicles based on available mobile server capabilities relative to requirements. The assignment circuit 104 can determine which vehicles should form platoons or caravans (e.g., in MaaS provider networks or fleets supporting such) to support optimal mobile edge server clusters, and in certain examples, plan vehicle routes. In other examples, passengers can be asked to share individual vehicles or to allow sharing of individual vehicles meeting specific requirements.

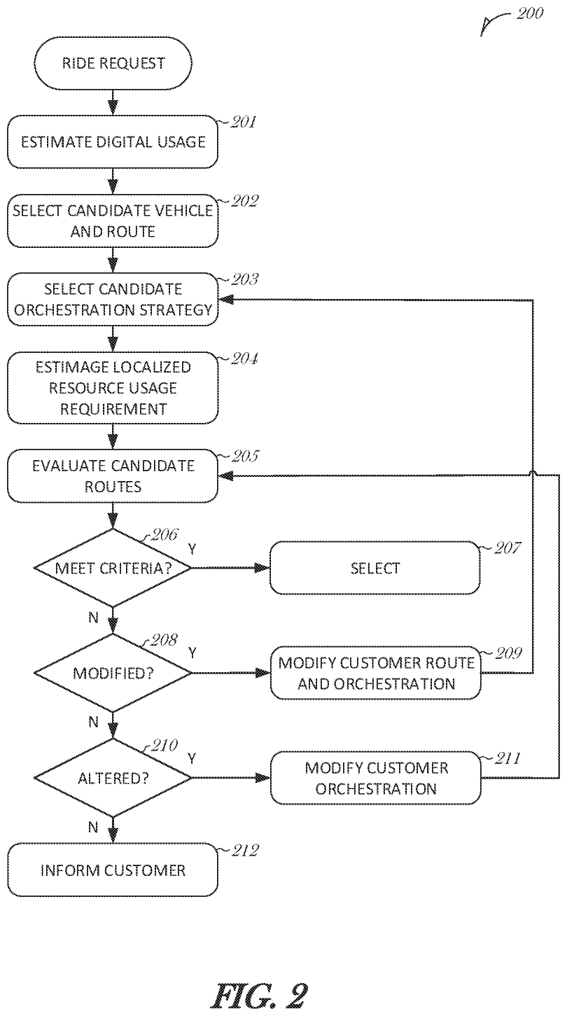

FIG. 2 illustrates an example method 200 of a route and orchestration planning process, which starts when a user request, such as a new ride request, is received for a user or a set of users. A ride request can be entered by the user into a reservation portal or application or can be automatically generated as a user enters a public transportation vehicle (e.g., a bus) that is part of the MaaS service network. The ride request can include information about an origin and a destination, as well as other information about vehicle preferences, digital resource preferences, history, or requests, etc. Although applicable to multiple users or different sets of users, a single user example will be discussed below. A user, while planning for or in a MaaS vehicle, can be considered a passenger.

At 201, digital resource usage requirements associated with the received user request can be estimated, such as based on previous usage history, service request requirements (e.g., requirements of one or more digital resource requests, etc.), etc. The estimate can include an estimate of required infrastructure resources necessary to meet the new ride request, such as of the passenger.

At 202, one or more candidate vehicles and routes, such as associated with the passenger, can be selected that meet the customer criteria for ride time, route restrictions, vehicle type, etc.

At 203, one or more candidate orchestration strategies for the requested services are selected. Dynamic resource cluster formation options can be selected if a selected orchestration plan calls for dynamic cluster formation. Example orchestration strategies include: (1) orchestrating the service in centralized cloud servers; (2) orchestrating the service on a vehicle mounted server; or (3) orchestrating the service on a combination of edge servers along the route and cloud infrastructure. Different workloads and customer requirements may require specific orchestration strategies for performance or security reasons. Workloads and customer requirements can be used to prune down the list of candidate orchestration strategies.

At 204, localized resource usage for each of the candidate routes and candidate orchestration strategies can be estimated. The localized resource usage can be determined for all resources that would be involved in providing the service as the passenger traverses the route, considering the expected time when each resource will be involved in providing the service. The outcome can be an advanced reservation for additional resources at a later segment of the route or a new route.

At 205, candidate routes and orchestration strategies can be evaluated, such as based on service delivery criteria, to prune candidates. Example evaluation criteria can include time constraints of the candidate routes, resource constraints in the infrastructure, or scoring the routes based on system-wide criteria, such as load balancing between resources to allow for the accommodation of additional passenger service requests. In an example, scores of different candidate routes and orchestrations can be compared to select the best route/orchestration combination, or to order possible selections to provide the user. The scores can be based on, for example, departure time from an origin, arrival time at a destination, transit time between the origin and the destination, transit distance, preferred MaaS vehicle (e.g;., vehicle type, vehicle comfort level, vehicle rating, etc.).

At 206, if a candidate route meets the desired criteria, the route can be selected at 207, and information associated with the selected route can be stored. Information associated with the selected route can include vehicle assignment, route planning information, dynamic clustering formation (if applicable), service orchestration plan, etc. Resource reservations can be generated for the infrastructure that will be involved for the estimated times of use and required software, data, or services can be prepared or pre-loaded. If the candidate route does not meet the desired criteria at 206, the route is not selected.

At 208, if an existing reservation, route, or vehicle assignment can be modified to free up resources required to meet the desired criteria, the modification can be made at 209 and a new candidate orchestration plan can be selected for the existing customer of the existing reservation, route, or vehicle assignment.

If the existing reservation, route, or vehicle assignment cannot be modified at 208, the service orchestration plan for an existing customer can be checked to determine if it can be modified to free up resources to accommodate the received request at 210. If so, the changes are made at 211. If no modifications can be made to the routes or orchestration plan of existing customers at 210, the process ends, and the customer is informed that the service cannot be provided while meeting the requested criteria. The customer can then decide whether to select different requirement or try again later.

Several variations in this process are possible. For example, the order in which existing passenger route or vehicle assignment and service orchestration plans are checked for possible changes can be switched, or the two processes can be performed in parallel.

In an example, the orchestration plan for a route or set of routes can indicate which workloads or microservices are to be performed on which server clusters at which time. Required software or data can be loaded onto a specified server or cluster of servers to be available when needed, and the server resources are freed when they are no longer being used or reserved for use. The orchestration plans can be adjusted dynamically as passengers and vehicles traverse the route because the timing of travel along the route may change due to unforeseen traffic conditions and server resource requirements may change due to unforeseen usage patterns or due to errors in the estimation process.

In an example, the system can continuously adjust resource reservations, orchestration plans, and resource usage estimates, and can monitor whether the expected resource usage in any server will exceed the available resources. If such a condition is detected, the method of FIG. 2 can be used to re-plan the routes and orchestration plans of passengers, for example, starting with passengers whose rides have not started, but also potentially including the remaining portions of routes of passengers who are already in transit.

From a resource orchestration perspective, the underlaying resource management system can attempt to keep the overall system in the state as requested. In resource constrained environments with mixed critical workloads, such as at the edge, it is possible that higher priory service components can, in some examples, preempt lower priority service components. With changing conditions, service components may not be guaranteed in all locations, but such service components may be available in locations or routes close to the selected route. In certain examples, routes can be altered or changed, even mid-route, to meet service requirements, such as, depending on received user input or preferences. In an example, the route of travel, from a time perspective, may be secondary to the services available along the route (e.g., latency, etc.).

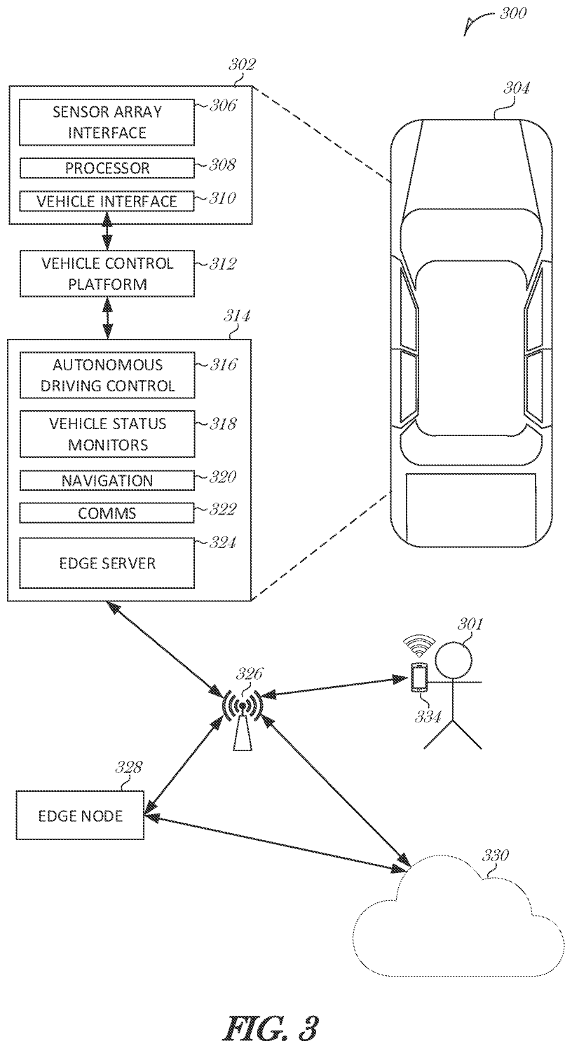

FIG. 3 illustrates an example system 300 to process data to provide improved interactions with the surrounding operating environment. FIG. 3 includes a processing platform 302 incorporated into the vehicle 304. The processing platform 302 includes a sensor array interface 306, a processor 308, and a vehicle interface 310.

The vehicle 304 (e.g., a MaaS vehicle, a host vehicle, etc.) may be any type of vehicle, such as a commercial vehicle, a consumer vehicle, a recreation vehicle, a car, a truck, a motorcycle, a boat, a drone, a robot, an airplane, a hovercraft, or any mobile craft able to operate at least partially in an autonomous mode. The vehicle 304 may operate in a manual mode where the driver operates the vehicle 304 conventionally using pedals, a steering wheel, or other controls. At other times, the vehicle 304 may operate in a fully autonomous mode, where the vehicle 304 operates without user intervention. In addition, the vehicle 304 may operate in a semi-autonomous mode, where the vehicle 304 controls many of the aspects of driving, but the driver may intervene or influence the operation using conventional (e.g., steering wheel) and non-conventional inputs (e.g., voice control).

The sensor array interface 306 may be used to provide input or output signaling to the processing platform 302 from one or more sensors of a sensor array installed on the vehicle 304. Examples of sensors include, but are not limited to microphones; forward, side, or rearward facing cameras; radar; LiDAR; ultrasonic distance measurement sensors; etc. The vehicle 304 may also include various other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like.

Sensor data is used to determine the vehicle's operating context, environmental information, road conditions, travel conditions, or the like. The sensor array interface 306 may communicate with another interface, such as an onboard navigation system, of the vehicle 304 to provide or obtain sensor data. Components of the processing platform 302 may communicate with components internal to the processing platform 302 or components that are external to the processing platform 302 using a network, which may include local-area networks (LAN), wide-area networks (WAN), wireless networks (e,g., 802.11 or cellular network), ad hoc networks, personal area networks (e.g., Bluetooth), vehicle-based networks (e.g., Controller Area Network (CAN) BUS), or other combinations or permutations of network protocols and network types. The network may include a single local area network (LAN) or wide-area network (WAN), or combinations of LANs or WANs, such as the Internet. The various devices coupled to the network may be coupled to the network via one or more wired or wireless connections.

The processing platform 302 may communicate with a vehicle control platform 312. The vehicle control platform 312 may be a component of a larger architecture that controls various aspects of the vehicle's operation. The vehicle control platform 312 may have interfaces to other vehicle platforms or subsystems 314, such as autonomous driving control systems 316 (e.g., steering, braking, acceleration, etc.), vehicle status monitors 318 (e.g., tire pressure monitor, oil level sensor, speedometer, etc.), comfort systems (e.g., heat, air conditioning, seat positioning, etc.), navigation systems 320 (e.g., maps and. routing systems, positioning systems, etc.), collision avoidance systems, communication systems 322, security systems, sensors (e.g., a camera, LiDAR, GPS, etc.), etc. Using the processing platform 302, the vehicle control platform 312 may control one or more subsystems.

The navigation systems 320 can include one or more navigation circuits comprising suitable circuitry, logic, interfaces and/or code used to generate and/or modify a navigation route based on navigation data (e.g., starting location and a destination location), vehicle data (e.g., vehicle type, dimensions or other vehicle data), user request information, digital resource usage, and network capabilities. In an example, the navigation circuit may be configured to determine a starting location for a user 301. The starting location may be selected, entered, or otherwise provided by the user 301 (e.g., via a UI, such as of a mobile device 334). In some embodiments, the starting location may be determined from an electronic calendar event specifying a starting location for an upcoming trip, or from an email communication associated with an email (or social media) account of the user 301. In some embodiments, the starting location may be determined by the navigation circuit using data obtained via the processing platform 302. For example, the starting location may be the current location of user 301, which may be determined using Global Positioning System (GPS) technology, Global Navigation Satellite System (GNSS) technology, indoor positioning (e.g., using Wi-Fi infrastructure), or other technologies for determining the current user location.

One or more components of the navigation systems 320 may be incorporated outside of the vehicle subsystems 314 (e.g., as a separate device or database). For example, a navigation databases may accessible in the cloud 330 via a communication network 326. Examples of communication networks include, but are not limited to, a LAN, a WAN, the Internet, mobile telephone networks, and wireless data networks (e.g., Wi-Fi and WiMAX networks). It is contemplated that other types of communication networks 326 are also within the scope of the present disclosure.

Separately from the cloud 330, the communication network 326 can include an edge server 328 located closer to the vehicle 304 than the cloud 330. In certain examples, the vehicle subsystems 314 can include an edge server 324 associated with the vehicle 304.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the Operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

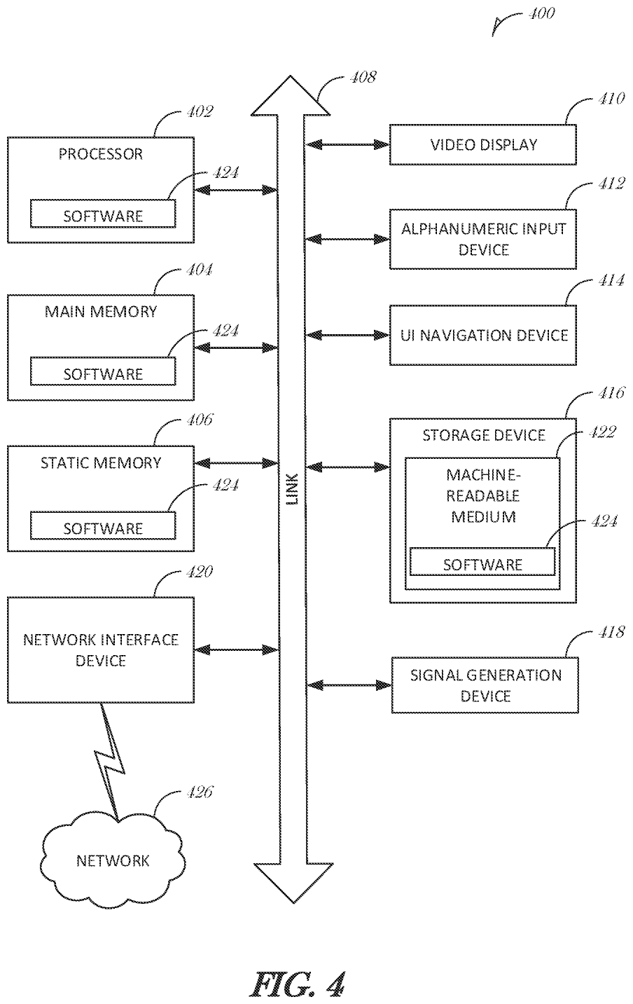

FIG. 4 illustrates an example machine in form of a computer system 400, within which a set or sequence of instructions may be executed to cause the machine to perform any one of the methodologies discussed herein. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise)) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408 (e.g., bus). The computer system 400 may further include a video display unit 410, an alphanumeric input device 412 (e.g., a keyboard), and a user interface (UI) navigation device 414 (e.g., a mouse). In one embodiment, the video display unit 410, input device 412 and UI navigation device 414 are incorporated into a touch screen display. The computer system 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, gyrometer, magnetometer, or other sensor.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly he taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, LoRa/LoRaWAN, or satellite communication networks). The term “transmission medium” shall be taken to include any intangible medium that is capable of storing, encoding, or carrying instructions for execution by the machine, and includes digital or analog communications signals or other intangible medium to facilitate communication of such software.

Example 1 is a system for route-based digital service management, the system comprising: a resource usage circuit configured to receive a request for service and to estimate digital resource usage with respect to the request; a resource requirement circuit configured to determine a MaaS route using the request and the estimated digital service usage; a resource management circuit configured to select an orchestration strategy comprising a server type using the estimated digital service usage; and an assignment circuit configured to schedule a MaaS vehicle for the determined MaaS route in response to the request using the selected orchestration strategy and the determined candidate MaaS route.

In Example 2, the subject matter of Example 1 includes, wherein the request for service comprises a user request for service, the user request for service comprising a ride share request from a MaaS provider and a quality-of-service (QoS) request for digital service over the determined MaaS route, wherein to determine the MaaS route comprises prioritize the QoS request for digital service over a time or distance of the determined MaaS route.

In Example 3, the subject matter of Examples 1-2 includes, wherein the resource usage circuit is configured to estimate digital service usage using an indication of past digital service usage of a user associated with the request, wherein to select the orchestration strategy comprises to select at least one of a cloud server, an edge server, or a vehicle-mounted server using the estimated digital service usage.

In Example 4, the subject matter of Examples 1-3 includes, wherein to determine the MaaS route comprises to determine a number of candidate MaaS routes using the request and the estimated digital service usage, and wherein the assignment circuit is configured to score the determined candidate MaaS routes.

In Example 5, the subject matter of Example 4 includes, wherein to schedule the MaaS vehicle comprises to schedule the MaaS vehicle associated with the highest score.

In Example 6, the subject matter of Examples 4-5 includes, wherein the assignment circuit is configured to order the number of candidate MaaS routes using the scores.

In Example 7, the subject matter of Examples 1-6 includes, wherein the resource requirement circuit is configured to aggregate resource usage of a MaaS or digital service provider associated with the determined MaaS route, and wherein the assignment circuit is configured to form a platoon of MaaS vehicles using the selected orchestration strategy and the determined candidate MaaS route to increase efficiency of network resources.

In Example 8, the subject matter of Examples 1-7 includes, wherein the request comprises a request for specific processing or communication resources, wherein to estimate digital service usage comprises with respect to the request for specific for specific processing or communication resources, wherein to determine the MaaS route comprises using the request for specific processing or communication resources, and wherein to select an orchestration strategy comprises using the request for specific processing or communication resources.

Example 9 is a method of route-based digital service management, the method comprising: receiving a user request for service from a MaaS or digital service provider; estimating digital service usage with respect to the user request; determining a MaaS route using the user request and the estimated digital service usage; selecting an orchestration strategy comprising a server type using the estimated digital service usage; and scheduling a MaaS vehicle for the determined MaaS route in response to the user request using the selected orchestration strategy and the determined candidate MaaS route.

In Example 10, the subject matter of Example 9 includes, wherein the user request for service comprises a quality-of-service (QoS) request for digital service over the determined MaaS route, and wherein determining the MaaS route comprises prioritizing the QoS request for digital service over a time or distance of the determined MaaS route.

In Example 11, the subject matter of Examples 9-10 includes, wherein selecting the orchestration strategy comprises selecting at least one of a cloud server, an edge server, or a vehicle-mounted server using the estimated digital service usage.

In Example 12, the subject matter of Examples 9-11 includes, wherein determining the MaaS route comprises determining a number of candidate MaaS routes using the user request and the estimated digital service usage, and wherein the method comprises scoring the determined candidate MaaS routes.

In Example 13, the subject matter of Example 12 includes, wherein scheduling the MaaS vehicle comprises scheduling the MaaS vehicle associated with the highest score.

In Example 14, the subject matter of Examples 12-13 includes, determining an order of the number of candidate MaaS routes to present to a user using the scores.

In Example 15, the subject matter of Examples 9-14 includes, aggregating resource usage of the MaaS or digital service provider associated with the determined MaaS route; and forming a platoon of MaaS vehicles using the selected orchestration strategy and the determined candidate MaaS route to increase efficient use of network resources.

In Example 16, the subject matter of Examples 9-15 includes, wherein the user request includes a request for specific processing or communication resources, wherein estimating digital service usage comprises with respect to the request for specific for specific processing or communication resources, wherein determining the MaaS route comprises using the request for specific processing or communication resources, and wherein selecting an orchestration strategy comprises using the request for specific processing or communication resources.

Example 17 is at least one machine-readable medium including instructions for route-based digital service management, the instructions, when executed by a machine, cause the machine to perform operations comprising: receiving a user request for service from a MaaS or digital service provider; estimating digital service usage with respect to the user request; determining a MaaS route using the user request and the estimated digital service usage; selecting an orchestration strategy comprising a server type using the estimated digital service usage; and scheduling a MaaS vehicle for the determined MaaS route in response to the user request using the selected orchestration strategy and the determined candidate MaaS route.

In Example 18, the subject matter of Example 17 includes, wherein the user request for service comprises a quality-of-service (QoS) request for digital service over the determined MaaS route, and wherein determining the MaaS route comprises prioritizing the QoS request for digital service over a time or distance of the determined MaaS route.

In Example 19, the subject matter of Examples 17-18 includes, wherein selecting the orchestration strategy comprises selecting at least one of a cloud server, an edge server, or a vehicle-mounted server using the estimated digital service usage.

In Example 20, the subject matter of Example 19 includes, wherein determining the MaaS route comprises determining a number of candidate MaaS routes using the user request and the estimated digital service usage, and wherein the operations comprise scoring the determined candidate MaaS routes.

Example 21 is at least one machine-readable medium including instructions that, when executed by processing circuitry, cause the processing circuitry to perform operations to implement of any of Examples 1-20.

Example 22 is a system comprising: means for receiving a user request for service from a MaaS or digital service provider; means for estimating digital service usage with respect to the user request; means for determining a MaaS route using the user request and the estimated digital service usage; means for selecting an orchestration strategy comprising a server type using the estimated digital service usage; and means for scheduling a MaaS vehicle for the determined MaaS route in response to the user request using the selected orchestration strategy and the determined candidate MaaS route.

In Example 23, the subject matter of Example 22 includes, wherein the user request for service comprises a quality-of-service (QoS) request for digital service over the determined MaaS route, and wherein means for determining the MaaS route comprises means for prioritizing the QoS request for digital service over a time or distance of the determined MaaS route.

In Example 24, the subject matter of Examples 22-23 includes, wherein means for selecting the orchestration strategy comprises means for selecting at least one of a cloud server, an edge server, or a vehicle-mounted server using the estimated digital service usage.

In Example 25, the subject matter of Examples 22-24 includes, wherein means for determining the MaaS route comprises means for determining a number of candidate MaaS routes using the user request and the estimated digital service usage, and wherein the system comprises means for scoring the determined candidate MaaS routes.

In Example 26, the subject matter of Example 25 includes, wherein means for scheduling the MaaS vehicle comprises means for scheduling the MaaS vehicle associated with the highest score.

In Example 27, the subject matter of Examples 25-26 includes, means for determining an order of the number of candidate MaaS routes to present to a user using the scores.

In Example 28, the subject matter of Examples 22-27 includes, means for aggregating resource usage of the MaaS or digital service provider associated with the determined MaaS route; and means for forming a platoon of MaaS vehicles using the selected orchestration strategy and the determined candidate MaaS route to increase efficient use of network resources.

In Example 29, the subject matter of Examples 22-28 includes, wherein the user request includes a request for specific processing or communication resources, wherein means for estimating digital service usage comprises with respect to the request for specific for specific processing or communication resources, wherein means for determining the MaaS route comprises using the request for specific processing or communication resources, and wherein means for selecting an orchestration strategy comprises

Example 30 is at least one machine-readable medium including instructions that, when executed by processing circuitry, cause the processing circuitry to perform operations to implement of any of Examples 1-29.

Example 31 is an apparatus comprising means to implement of any of Examples 1-29.

Example 32 is a system to implement of any of Examples 1-29.

Example 33 is a method to implement of any of Examples 1-29.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more,” In this document, the term “or” is used to refer to a nonexclusive or, such that “A or B” includes “A but not B,” “B but not A,” and “A and B,” unless otherwise indicated. In the appended. claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system comprising:
a resource usage circuit configured to receive a request for service and to estimate digital resource usage with respect to the request;
a resource requirement circuit configured to determine a MaaS route based on the request and the estimated digital service usage;
a resource management circuit configured to select an orchestration strategy comprising a server type using the estimated digital service usage; and
an assignment circuit configured to schedule a MaaS vehicle for the determined MaaS route in response to the request using the selected orchestration strategy and the determined candidate MaaS route.

2. The system of claim 1, wherein the request for service comprises a user request for service, the user request for service comprising a ride request from a MaaS provider and a quality-of-service (QoS) request for digital service over the determined MaaS route, and
wherein to determine the MaaS route comprises prioritize the QoS request for digital service over a time or distance of the determined MaaS route.

3. The system of claim 1, wherein the resource usage circuit is configured to estimate digital service usage using an indication of past digital service usage of a user associated with the request, and
wherein to select the orchestration strategy comprises to select at least one of a cloud server, an edge server, or a vehicle-mounted server using the estimated digital service usage.

4. The system of claim 1, wherein to determine the MaaS route comprises to determine a number of candidate MaaS routes using the request and the estimated digital service usage, and
wherein the assignment circuit is configured to score the determined candidate MaaS routes.

5. The system of claim 4, wherein, to schedule the MaaS vehicle, the assignment circuit is configured to schedule the MaaS vehicle with the highest score.

6. The system of claim 4, wherein the assignment circuit is configured to order or rank the number of candidate MaaS routes using the scores.

7. The system of claim 1, wherein the resource requirement circuit is configured to aggregate resource usage of a MaaS or digital service provider associated with the determined MaaS route, and
wherein the assignment circuit is configured to form a platoon of MaaS vehicles using the selected orchestration strategy and the determined candidate MaaS route to increase efficiency of network resources.

8. The system of claim 1, wherein the request comprises a request for specific processing or communication resources,
wherein to estimate digital service usage comprises with respect to the request for specific processing or communication resources,
wherein to determine the MaaS route comprises using the request for specific processing or communication resources, and
wherein to select an orchestration strategy comprises using the request for specific processing or communication resources.

9. A system comprising:
means for receiving a user request for service from a MaaS or digital service provider;
means for estimating digital service usage with respect to the user request;
means for determining a MaaS route using the user request and the estimated digital service usage;
means for selecting an orchestration strategy comprising a server type using the estimated digital service usage; and
means for scheduling a MaaS vehicle for the determined MaaS route in response to the user request using the selected orchestration strategy and the determined candidate MaaS route.

10. The system of claim 9, wherein the user request for service comprises a quality-of-service (QoS) request for digital service over the determined MaaS route, and
wherein means for determining the MaaS route comprises means for prioritizing the QoS request for digital service over a time or distance of the determined MaaS route.

11. The system of claim 9, wherein means for selecting the orchestration strategy comprises means for selecting at least one of a cloud server, an edge server, or a vehicle-mounted server using the estimated digital service usage.

12. The system of claim 9, wherein means for determining the MaaS route comprises means for determining a number of candidate MaaS routes using the user request and the estimated digital service usage, and,
wherein the system comprises
means for scoring the determined candidate MaaS routes.

13. The system of claim 12, wherein means for scheduling the MaaS vehicle comprises means for scheduling the MaaS vehicle associated with the highest score.

14. The system of claim 12, comprising means for determining an order of the number of candidate MaaS routes to present to a user using the scores.

15. The system of claim 9, comprising:
means for aggregating resource usage of the MaaS or digital service provider associated with the determined MaaS route; and
means for forming a platoon of MaaS vehicles using the selected orchestration strategy and the determined candidate MaaS route to increase efficient use of network resources.

16. The system of claim 9, wherein the user request includes a request for specific processing or communication resources,
wherein means for estimating digital service usage comprises with respect to the request for specific for specific processing or communication resources,
wherein means for determining the MaaS route comprises using the request for specific processing or communication resources, and
wherein means for selecting an orchestration strategy comprises using the request for specific processing or communication resources.

17. At least one non-transitory machine-readable medium including instructions for route-based digital service management, the instructions, when executed by hardware circuity, cause the hardware circuitry to perform operations comprising:
receiving a user request for service from a MaaS or digital service provider;
estimating digital service usage with respect to the user request;
determining a MaaS route using the user request and the estimated digital service usage;
selecting an orchestration strategy comprising a server type using the estimated digital service usage; and
scheduling a MaaS vehicle for the determined MaaS route in response to the user request using the selected orchestration strategy and the determined candidate MaaS route.

18. The at least one machine-readable medium of claim 17, wherein the user request for service comprises a quality-of-service (QoS) request for digital service over the determined MaaS route, and
wherein determining the MaaS route comprises prioritizing the QoS request for digital service over a time or distance of the determined MaaS route.

19. The at least one machine-readable medium of claim 17, wherein selecting the orchestration strategy comprises selecting at least one of a cloud server, an edge server, or a vehicle-mounted server using the estimated digital service usage.

20. The at least one machine-readable medium of claim 19, wherein determining the MaaS route comprises determining a number of candidate MaaS routes using the user request and the estimated digital service usage, and
wherein the operations comprise scoring the determined candidate MaaS routes.
